(19) United States
(12) Patent Application Publication
(10) Pub. No.: US 2002/0046132 A1
(43) Pub. Date: Apr. 18, 2002

(54) Method of selecting feminine care products and processing orders therefor

(76) Inventors: Julie A. Raye, Sherwood, WI (US); Aida E. Flick, Menasha, WI (US); Wanda W. Jackson, Alpharette, GA (US); Betsy C. Westlake, Appleton, WI (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/918,049

(22) Filed: Jul. 30, 2001

Related U.S. Application Data
(60) Provisional application No. 60/240,673, filed on Oct. 16, 2000.

(51) Int. Cl. G06F 17/60

(52) U.S. Cl. 705/26

(57) ABSTRACT

A method of processing a purchase order for a consumer-specific assortment of feminine care products, which may include non-commercial quantities of absorbent catamenial products, is preferably implemented via an Internet web site, allowing consumers to conveniently and discretely place purchase orders for such product assortments. The ordered assortment can be delivered on or about a target delivery date specified by the consumer. The custom product assortment may include other types of feminine care products typically needed by the consumer on a monthly basis, including contraceptives and menstrual cramping medication. The consumer-specific assortment of feminine care products may be determined by prompting the consumer for certain detailed information related to her monthly cycle and then processing this information to produce a consumer-specific recommendation.

### REFERENCE TO RELATED APPLICATION

This application claims the benefit of U.S. Provisional Application No. 60/240,673, filed Oct. 16, 2000, the entire disclosure of which is incorporated herein by reference.

### FIELD OF THE INVENTION

This invention relates to a method of selecting consumer-specific assortments of feminine care products and processing purchase orders therefor.

### BACKGROUND OF THE INVENTION

Absorbent feminine care products including tampons, sanitary napkins (“pads”) and pantiliners have historically been sold in commercial quantities only, such as packages containing ten to more than one hundred products of the same product type. More recently, it has been suggested to sell these absorbent products in non-commercial quantities (i.e., less than ten articles of the same product type) as well so as to permit a consumer needing only a few articles of a given type during her monthly cycle to obtain such articles without having to purchase (and store) a larger than needed quantity. According to the prior art, an in-store display stand is used to dispense absorbent feminine care products individually or in packages of two to nine products per package. After a consumer retrieves the needed products or assortment of products from the in-store display stand, the consumer can proceed to the checkout register where these products will be scanned or “rung up” for purchase, and then bagged along with any other items purchased by the consumer.

It has also been suggested to provide consumers with a means for identifying custom assortments of absorbent products that best meet the individual needs of each customer. For example, it is known to use an interactive computer for prompting a consumer to answer questions relating to her monthly cycle, for keeping track of the consumer's answers to such questions, and then selecting an appropriate assortment of absorbent products based upon the consumer's answers. This interactive computer can be implemented via the Internet or in conjunction with the above-described in-store display stand. Either way, once a consumer obtains a recommendation relating to an assortment of absorbent products expected to best meet that particular consumer's needs, the consumer can proceed to procure the recommended assortment of absorbent products from the in-store display stand described above.

As recognized by the inventors hereof, many consumers will be reluctant to procure absorbent feminine care products individually or in small quantities from an in-store display stand, despite the advantage of obtaining the particular product types and quantities needed by each consumer. This is due not only to the inconvenient and cumbersome nature of retrieving what may be numerous packages of such products from an in-store display stand (in contrast to purchasing one or more boxes of such products in commercial quantities), but also the possibility if not probability of drawing unwanted attention, both at the in-store display stand and then again at the checkout counter, to the intimate products being purchased. The inventors hereof have also recognized that, by collecting and processing certain types of data either in addition to or instead of the data types used in the prior art, a better recommendation of a consumer-specific assortment of absorbent products can be made.

### SUMMARY OF THE INVENTION

In order to solve these and other needs in the art, the inventors hereof have succeeded at designing a method for processing a purchase order for a consumer-specific assortment of feminine care products which may include, as necessary, non-commercial quantities of absorbent catamenial products. The method is preferably implemented via an Internet web site, thereby allowing consumers to place purchase orders for such product assortments from the comfort and privacy of their homes, workplaces, etc. The ordered assortment of products can then be delivered, for example, to an address specified by the consumer on or about a target delivery date also specified by the consumer. In this manner, the consumer can conveniently and discretely obtain a custom mix of products tailored to her individual needs, preferably just prior to when the need for such products will arise, thereby eliminating any need for the consumer to store such products for an extended period of time such as several months. In addition to absorbent catamenial products, the custom product assortment may include other types of feminine care products typically needed by the consumer on a monthly basis, including contraceptives and menstrual cramping medication. The inventors have also developed a method for determining the consumer-specific assortment of feminine care products by prompting the consumer to provide certain detailed information related to her monthly cycle and then processing this information to produce a consumer-specific recommendation.

In accordance with one aspect of the present invention, a method of processing a purchase order for a consumer-specific assortment of feminine care products includes the steps of determining at a first location an assortment of feminine care products for a consumer at a second location remote from the first location based on information provided by the consumer, the determined assortment of feminine care products including a non-commercial quantity of at least one type of absorbent catamenial product, and accepting at the first location a purchase order placed by the consumer at the second location for at least the determined assortment of feminine care products.

In accordance with another aspect of the present invention, a method of processing a purchase order for a consumer-specific assortment of feminine care products includes the steps of collecting at a first location information from a consumer at a second location remote from the first location, said information relating to the consumer's monthly cycle, recommending to the consumer at the second location an assortment of feminine care products based upon the collected information, and accepting at the first location a purchase order placed by the consumer at the second location for at least the recommended assortment of feminine care products.

In accordance with yet another aspect of the present invention, a method for determining a consumer-specific assortment of feminine care products includes the steps of collecting information from the consumer related to her monthly cycle, processing the information collected from the consumer, and recommending to the consumer an assortment of feminine care products based upon the processed information.

In accordance with still another aspect of the present invention, a method of processing a purchase order for a feminine care kit includes the steps of prompting a consumer to place a purchase order for a feminine care kit including at least one type of absorbent catamenial product and at least one additional product selected from the group consisting of menstrual cramp medication, contraceptives, and ovulation tests, and accepting the purchase order placed by the consumer.

Other features and advantages of the present invention will be in part apparent and in part pointed out hereinafter.

### BRIEF DESCRIPTION OF THE DRAWINGS

FIG. 1 is a flow chart illustrating an exemplary method of processing a purchase order for a consumer-specific assortment of feminine care products according to the present invention.

FIG. 2 is a flow chart illustrating several preferred steps for determining an assortment of feminine care products for a particular consumer.

### DETAILED DESCRIPTION OF PREFERRED EMBODIMENTS

As used herein, “feminine care products” includes catamenial products, contraceptives, feminine deodorants, powders, wipes, washes, and cleaning solutions, douches, yeast infection medication, vaginal creams and lubricants, incontinence products, ovulation tests, pregnancy tests, pre-menstrual syndrome (“PMS”) and menstrual cramp medications, yeast detection tests, vaginitis detection tests, and vaginitis treatments. “Catamenial products” as used herein includes products intended for absorbing or collecting menstrual exudates. Thus, as used herein, “absorbent catamenial products” includes tampons, pads, pantiliners, feminine wipes, and interlabial products.

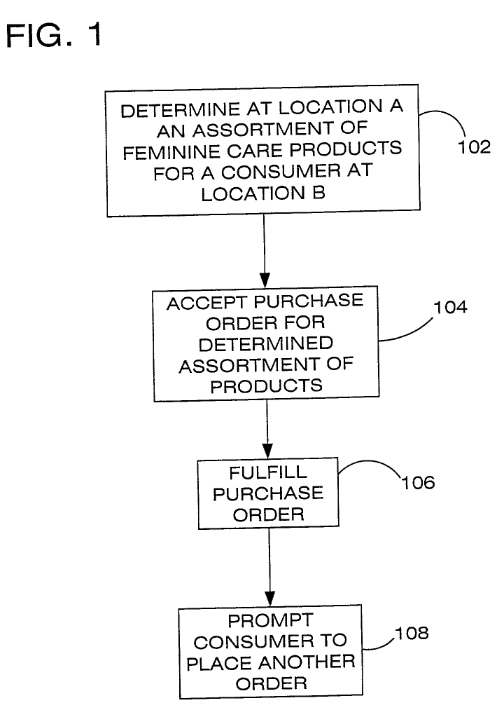

An exemplary method of processing a purchase order for a consumer-specific assortment of feminine care products according to the present invention is illustrated by the flow chart in FIG. 1 and designated generally by reference character 100.

Beginning at block 102 of FIG. 1, the preferred method 100 includes the step of determining, at a first location A, an assortment of feminine care products for a particular consumer at a second remote location B based upon information provided by the consumer from the remote location. In one preferred embodiment, the exemplary method is implemented via an Internet web site, the first location A is the location of a computer system hosting the web site, and the remote location B may be, for example, the consumer's home or office.

The determined assortment of feminine care products preferably includes a non-commercial quantity (i.e., less than ten) of at least one type of absorbent catamenial product, and more preferably includes non-commercial quantities of multiple types of absorbent catamenial products. In other words, the determined assortment of feminine care products preferably includes a custom mix of absorbent catamenial products expected to meet the consumer's needs (as determined by the consumer and/or by the party or system implementing the exemplary method) for one menstrual cycle (i.e., typically on the order of twenty-eight days for most women; also referred to herein as “monthly cycle”). It should therefore be understood that this mix of catamenial products is preferably determined without regard to the commercial quantities in which absorbent catamenial products have historically been sold. As an example, a custom mix of absorbent catamenial products expected to meet a particular consumer's needs for one monthly cycle, as determined in block 102, may include five different types of absorbent catamenial products, such as two KOTEX® Overnight Maxi Pads, four KOTEX® Ultra Thin Maxi Pads, ten KOTEX® SECURITY® Super Tampons, ten KOTEX® SECURITY® Regular Tampons, and ten KOTEX® LIGHTDAYS® Regular Pantiliners. Although the determined assortment of products preferably includes one or more types of absorbent catamenial products, it may and preferably does include other types of feminine care products including menstrual cramp medication and contraceptives, as further explained below.

After an assortment of feminine care products has been determined for the consumer in block 102, the exemplary method 100 continues at block 104 with the step of accepting a purchase order placed by the consumer for the determined assortment of feminine care products (and perhaps for one or more other products as well). In the case where the determined assortment of products is expected to meet the consumer's needs for one monthly cycle, a purchase order for any integer multiple of the determined assortment as a whole is preferably accepted. Thus, the consumer could elect to purchase three identical product assortments for meeting her needs over three monthly cycles. Additionally, the consumer is preferably allowed to place a standing order to have one or more of the determined product assortments delivered (or otherwise provided) to the consumer on a regular basis. As an example, the consumer could place a standing order to have the determined assortment of products delivered to her home every twenty-eight days until the standing order is canceled or modified.

In one preferred embodiment, the purchase order accepted in block 104 includes payment information from the consumer, such as credit or debit card information, which can be used to pay for the ordered assortment of feminine care products (including payment of shipping and handling charges, as applicable). Additionally, the purchase order preferably identifies a target delivery date, that is, a date on which the consumer would like to receive the ordered assortment of products. In this manner, the consumer can preferably receive the ordered products just prior to when they are needed, and not so far in advance that the consumer is burdened with storing such products for an extended period of time.

Following acceptance of the purchase order placed by the consumer, the exemplary method 100 continues at block 106 with the step of fulfilling the accepted purchase order. This is preferably accomplished by gathering the assortment of products and then shipping, via the United States Postal Service or a private carrier, the ordered assortment of feminine care products to an address specified by the consumer. Alternatively, the step of fulfilling the accepted purchase order may be accomplished by transferring the accepted purchase order to another party for fulfillment. For example, the accepted purchase order could be transferred for fulfillment to a retail establishment familiar to or located near the consumer, and such retail establishment could gather the ordered assortment of feminine care products for delivery to or pickup by the consumer.

The exemplary method may be implemented via a wired and/or wireless computer network, and is preferably implemented via a widely distributed computer network such as the Internet. Thus, the information provided by the consumer from location B (which is used to determine the consumer-specific assortment of feminine care products in block 102) is preferably provided by the consumer through an Internet web site, as is the purchase order placed by the consumer for the determined assortment. Alternatively, the consumer can otherwise provide such information and place purchase orders remotely by phone, facsimile, email and/or mail.

It should be understood that the determining, accepting and purchasing steps illustrated in FIG. 1 may all be performed at the same location A, or at two or three different locations, as desired for any given implementation of the invention.

As should already be apparent, the exemplary method 100 of the present invention enables a consumer to identify a custom mix of absorbent catamenial products expected to meet her needs for one monthly cycle without reference to the commercial quantities in which such products have historically been sold. Thus, a consumer needing, for example, only two or three heavy protection tampons per cycle can preferably purchase just that, rather than a commercial quantity of ten or more heavy protection tampons which the consumer would not fully deplete for several months. Moreover, the invention allows the consumer to conveniently place a purchase order for such products by phone, fax or over the Internet from the comfort and privacy of the consumer's home, office or elsewhere. The ordered assortment of feminine care products is then gathered and delivered to or picked up by the consumer all at once. This is in contrast to the prior art, where a consumer must travel to a retail establishment and then select from a product dispenser each of the product types and quantities desired, quite possibly while attracting unwanted attention, only to then have to proceed to a checkout register where a clerk must scan or “ring up” each of numerous separate catamenial products, quite possibly creating additional unwanted attention for the consumer. This prior art process is also more time consuming and subject to error. Thus, according to the present invention, a consumer can conveniently, discretely and remotely obtain the specific feminine care products the consumer needs, and when they are needed.

With further reference to FIG. 1, in the case of a first time user of the exemplary method 100, the step of fulfilling the consumer's purchase order in block 106 is preferably performed by delivering the ordered products to the consumer in a reusable storage container from which the products can be easily retrieved by the consumer. Thereafter, subsequent product orders can be delivered to the consumer as refills, which the consumer can then store in the reusable container that accompanied the initial delivery of ordered products.

Preferably, the fulfilling step includes the step of delivering the ordered products to the consumer along with instructional information relating to how such products should be used. In the case where the product assortment includes multiple types of catamenial products, the instructional information preferably informs the consumer when to use each product type (for example, thick pads should be used while sleeping, tampons should be used while physically active, etc.).

As shown in block 108 of FIG. 1, the exemplary method 100 preferably includes the additional step of prompting the consumer to place another purchase order for an assortment of feminine care products (assuming the consumer does not have a standing purchase order in place). In one preferred embodiment, this step is performed by sending to the consumer email, preferably on a periodic basis such as every twenty-eight days, which asks whether the consumer would like to place another purchase order. Preferably, the consumer can then place another purchase order either by return email or by accessing the web site through which her prior order was placed. In this manner, the consumer is conveniently reminded to purchase certain feminine care products in advance of when such products will be needed. As alternatives to email, the consumer can be contacted and prompted to place another purchase order via phone, fax or mail.

Referring again to block 102, the information which is provided by the consumer, and which is used to determine her assortment of feminine care products, may represent a selection by the consumer herself of products that should comprise her assortment. For example, in the case where the method is implemented via an Internet web site, the consumer may simply click on certain illustrated products, icons or descriptions, thereby adding such products to the consumer's shopping cart, to specify the particular products that will comprise her assortment of feminine care products.

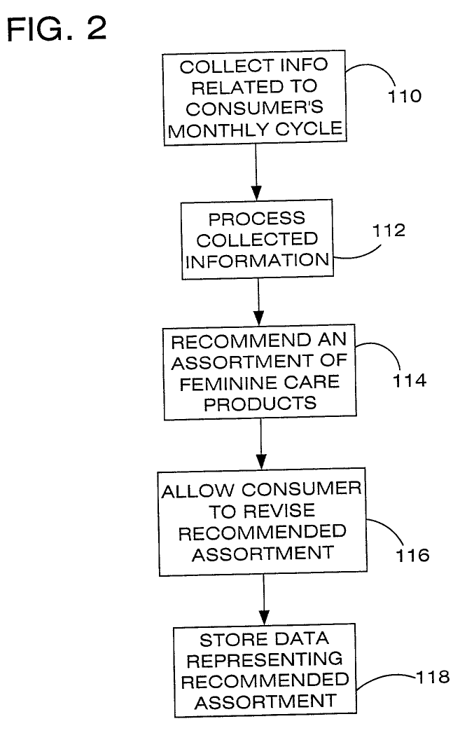

Alternatively, the step performed in block 102 of FIG. 1 may include the steps of collecting information from the consumer related to her monthly cycle, processing the information collected from the consumer, and then recommending to the consumer an assortment of feminine care products based upon the processed information, as illustrated in blocks 110, 112, 114, respectively, of FIG. 2. In one preferred embodiment, information relating to the consumer's monthly cycle is collected in block 110 by presenting the consumer with one or more specific questions, as further explained below. The consumer's answers to such questions are then processed in block 112, preferably by a suitably configured computer or by an individual having specialized knowledge in the field of feminine care products and/or access to a suitably configured computer, charts, or other aids for making custom product recommendations. The method then continues at block 114 with the step of recommending to the consumer an assortment of feminine care products based upon the processed information. At block 116, the consumer is preferably allowed to revise the recommended assortment of feminine care products. In this manner, the consumer is provided input into the product selection process. The consumer can then proceed to place a purchase order for the recommended and possibly revised assortment of products.

Illustrated in block 118 of FIG. 2 is the step of storing data representing the assortment of feminine care products as recommended to and possibly revised by the consumer. This stored data can be subsequently retrieved and used with the consumer such as, for example, the next time the consumer accesses a web site implementing the exemplary method under discussion. In this manner, the consumer need not have an assortment of feminine care products determined anew each time the consumer seeks to place another purchase order, and can instead view a previously recommended assortment of products. This approach also allows the consumer to modify or “tweak” her custom list of needed products over time to ultimately arrive at an ideal product assortment, or to adjust for changes in the consumer's needs or cycle. As should be apparent to those skilled in the art, the stored data may also be useful for studying consumer and product demands, etc. Further, the stored data can be used in block 108 of FIG. 1 when prompting the consumer to place another purchase order for an assortment of feminine care products. That is, the stored data can be used to advise the consumer of a previously ordered product assortment before asking whether the consumer would like to place another purchase order for that same or another assortment of products.

Although described above in conjunction with FIG. 1, it should be understood that the steps of FIG. 2 can also be implemented independently to assist women with identifying an assortment of feminine care products tailored to their individual needs. Thus, the steps of FIG. 2 can be implemented via an Internet web site, as described above, or via, for example, a suitably configured computer located in a retail establishment (preferably in the vicinity of absorbent catamenial products) for use by or on behalf of consumers.

As noted above, the step of collecting information related to the consumer's monthly cycle, illustrated in block 110 of FIG. 2, can be implemented by presenting one or more questions to the consumer. In addition to possibly asking the consumer about her body size and/or perceived menstrual flow, a variety of other information is preferably collected from the consumer (e.g., in the form of answers to questions) to assist in making the most appropriate recommendation of feminine care products for the consumer's individual needs. For example, information is preferably collected from the consumer relating to the consumer's level of physical activity while using an absorbent product, preferably both while awake and while sleeping (e.g., some woman frequently toss and turn, sleepwalk, or make frequent trips to the bathroom during the night). The more physically active a consumer is, the more appropriate it may be to recommend tampons, thin (versus thick) pads, and/or pads with wings. It is also useful to collect information relating to whether the consumer tends to sleep on her side rather than on her stomach or back, as this may suggest the need for pads provided with wings, in the case where pads will be recommended. Further, information is preferably collected relating to the frequency at which the consumer replaces an absorbent catamenial product, such as a pad or tampon, both during waking hours and during the night (or otherwise during a period of sleep). Such information may be particularly useful since a consumer that frequently replaces a used absorbent product with a fresh product will more likely need a greater quantity of products having less capacity than if the products were changed more frequently.

Additionally, the consumer is preferably asked whether there are any particular types of absorbent catamenial products, or other feminine care products, which the consumer prefers not to use. In this manner, a custom mix of products can be recommended to the consumer which does not include products that the consumer does not want or will not use. The collected information may also include information related to the type of undergarment worn by the consumer while using an absorbent product. For example, it will typically be more appropriate to recommend use of tampons versus pads for women who wear thong panties or no panties at all.

In addition to collecting information useful in recommending an assortment of absorbent catamenial products for a consumer, information may also be collected related to other feminine care products, such as the type of contraceptives and/or menstrual cramping medications used or preferred by the consumer. In this manner, a more complete recommendation of feminine care products can be fashioned for the consumer. In this regard, it should be noted that according to the present invention, a consumer is preferably prompted to place a purchase order for a “feminine care kit” that includes not only one or more types of absorbent catamenial products, but also contraceptives, menstrual cramping medications, and/or ovulation tests as well. As a result, a consumer can conveniently place a comprehensive purchase order for a variety of feminine care products which the consumer may typically need on a monthly basis, preferably from the privacy of the consumer's home or office. This is in contrast to the prior art, where a consumer may, for example, purchase absorbent catamenial products from a discount store, menstrual cramping medication from a drugstore, and contraceptives through a doctor's office, mail order service, or drugstore.

Information may also be collected from the consumer relating to whether the consumer is interested in becoming pregnant. If the consumer is so interested, the recommended assortment of products preferably includes an ovulation test to assist the consumer in determining when she is ovulating.

It should be understood that any one or more types of information described above can be collected from a consumer in any given implementation of the present invention. Further, the recommended assortment of products (in the case where a recommendation of products is provided to the consumer) is preferably determined by processing all information collected from the consumer, although certain types of collected information may largely control the types of feminine care products recommended to a particular consumer, as will be apparent to those skilled in the art.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed:

1. A method of processing a purchase order for a consumer-specific assortment of feminine care products, the method comprising the steps of:
determining at a first location an assortment of feminine care products for a consumer at a second location remote from the first location based on information provided by the consumer, the determined assortment of feminine care products including a non-commercial quantity of at least one type of absorbent catamenial product; and
accepting at the first location a purchase order placed by the consumer at the second location for at least the determined assortment of feminine care products.

2. The method of claim 1 wherein said information is provided and said purchase order is placed by the consumer through a computer network.

3. The method of claim 1 wherein the determined assortment of feminine care products includes non-commercial quantities of multiple types of absorbent catamenial products.

4. The method of claim 1 wherein the determined assortment of feminine care products includes at least one product selected from the group consisting of menstrual cramp medication and contraceptives.

5. The method of claim 1 wherein said information represents a selection by the consumer of products which comprise the assortment.

6. The method of claim 1 wherein the determining step includes presenting questions to the consumer regarding her monthly cycle, and said information represents the consumer's answers to said questions.

7. The method of claim 1 wherein the purchase order includes payment information.

8. The method of claim 1 wherein the purchase order includes a target delivery date.

9. The method of claim 1 further comprising the step of storing data representing the determined assortment of feminine care products for subsequent retrieval and use with the consumer.

10. The method of claim 1 further comprising the step of fulfilling the purchase order placed by the consumer.

11. The method of claim 10 wherein the fulfilling step includes delivering the ordered assortment of feminine care products to the consumer.

12. The method of claim 11 wherein the fulfilling step includes delivering the ordered assortment of feminine care products to the consumer along with a reusable storage container for said products.

13. The method of claim 12 wherein the fulfilling step includes delivering a subsequent order of feminine care products to the consumer without a reusable storage container for said products.

14. The method of claim 1 further comprising the step of prompting the consumer to place another purchase order for an assortment of feminine care products.

15. The method of claim 14 wherein the prompting step includes sending email to the consumer.

16. The method of claim 14 wherein the prompting step includes periodically prompting the consumer to place another purchase order for an assortment of feminine care products.

17. The method of claim 14 wherein the prompting step includes advising the consumer of the assortment of feminine care products last ordered by the consumer.

18. A method of processing a purchase order for a consumer-specific assortment of feminine care products, the method comprising the steps of:
collecting at a first location information from a consumer at a second location remote from the first location, said information relating to the consumer's monthly cycle;
recommending to the consumer at the second location an assortment of feminine care products based upon the collected information; and
accepting at the first location a purchase order placed by the consumer at the second location for at least the recommended assortment of feminine care products.

19. The method of claim 18 wherein the recommended assortment of feminine care products includes multiple types of absorbent catamenial products.

20. The method of claim 18 wherein the recommended assortment of feminine care products includes a non-commercial quantity of at least one type of absorbent catamenial product.

21. The method of claim 20 wherein the recommended assortment of feminine care products includes non-commercial quantities of multiple types of absorbent catamenial products.

22. The method of claim 18 wherein the recommended assortment of feminine care products includes at least one product selected from the group consisting of menstrual cramp medication, contraceptives and ovulation tests.

23. The method of claim 18 wherein the collecting, recommending and accepting steps are performed using a computer.

24. The method of claim 23 wherein the collecting, recommending and accepting steps are performed through a computer network to which said computer is connected.

25. The method of claim 18 further comprising the step of allowing the consumer to revise the recommended assortment of feminine care products prior to placing a purchase order therefor.

26. The method of claim 18 wherein the recommending step includes recommending an assortment of feminine care products expected to meet the consumer's needs for one monthly cycle.

27. The method of claim 26 wherein the accepting step includes accepting a purchase order from the consumer for multiple units of the recommended assortment of feminine care products.

28. The method of claim 18 wherein the accepting step includes accepting a standing purchase order for the recommended assortment of feminine care products.

29. The method of claim 18 further comprising the step of storing data representing the recommended assortment of feminine care products.

30. The method of claim 18 further comprising the step of fulfilling the purchase order accepted from the consumer.

31. The method of claim 30 wherein the fulfilling step includes delivering the recommended assortment of feminine care products to the consumer.

32. A method for determining a consumer-specific assortment of feminine care products, the method comprising the steps of:
collecting information from the consumer related to her monthly cycle;
processing the information collected from the consumer; and
recommending to the consumer an assortment of feminine care products based upon the processed information.

33. The method of claim 32 wherein the collecting step includes collecting information related to the consumer's physical activity while using an absorbent catamenial product.

34. The method of claim 32 wherein the collecting step includes collecting information related to absorbent catamenial products which the consumer prefers not to use.

35. The method of claim 32 wherein the collecting step includes collecting information related to a type of undergarment worn by the consumer while menstruating.

36. The method of claim 32 wherein the collecting step includes collecting information related to the consumer's sleeping habits.

37. The method of claim 36 wherein the collecting step includes collecting information related to whether the consumer is a side sleeper.

38. The method of claim 36 wherein the collecting step includes collecting information related to the frequency at which the consumer changes an absorbent catamenial product during a period of sleep.

39. The method of claim 32 wherein the collecting step includes collecting information related to the frequency at which the consumer changes an absorbent catamenial product during waking hours.

40. The method of claim 32 wherein the collecting step includes collecting information related to the type of birth control used by the consumer.

41. The method of claim 32 wherein the collecting step includes collecting information related to menstrual cramping medication.

42. The method of claim 32 further comprising the step of accepting a purchase order from the consumer for at least the recommended assortment of feminine care products.

43. The method of claim 42 further comprising the steps of allowing the consumer to revise the recommended assortment of feminine care products and accepting a purchase order for said recommended assortment as revised by the consumer.

44. The method of claim 32 wherein the consumer is at a first location and the processing step is performed at a second location remote from the first location.

45. A method of processing a purchase order for a feminine care kit, the method comprising the steps of:
prompting a consumer to place a purchase order for a feminine care kit including at least one type of absorbent catamenial product and at least one additional product selected from the group consisting of menstrual cramp medication and contraceptives; and
accepting the purchase order placed by the consumer.

46. The method of claim 45 wherein the feminine care kit includes at least two products selected from said group.

47. The method of claim 46 wherein the feminine care kit includes all three products from said group.

48. The method of claim 45 wherein the prompting step and the accepting step are performed using a computer.

49. The method of claim 48 wherein the prompting step and the accepting step are performed through a computer network to which said computer is connected.

50. The method of claim 45 wherein the prompting step includes collecting information from the consumer related to her monthly cycle and recommending a feminine care kit comprising products selected according to the collected information.

51. The method of claim 45 further comprising the step of fulfilling the accepted purchase order.

52. The method of claim 45 wherein the consumer is at a first location and the prompting step is performed at a second location remote from the first location.

53. The method of claim 32 wherein the collecting step includes collecting information related to a type of undergarment worn by the consumer while not menstruating.

54. The method of claim 53 wherein the recommending step includes recommending thong pantiliners for a consumer who wears thong underwear while not menstruating.
